(19) United States
(12) Patent Application Publication
(10) Pub. No.: US 2023/0376550 A1
(43) Pub. Date: Nov. 23, 2023

(54) A METHOD OF FLOCK ENGINE WITH BLOCKCHAIN AUDITING

(71) Applicants: Sridhar Seshadri, Silicon Valley, Madhapur, Hyderabad (IN); Shreeram Iyer, Silicon Valley, Madhapur, Hyderabad (IN)

(72) Inventors: Sridhar Seshadri, Silicon Valley, Madhapur, Hyderabad (IN); Shreeram Iyer, Silicon Valley, Madhapur, Hyderabad (IN)

(21) Appl. No.: 18/028,171

(22) PCT Filed: Nov. 16, 2020
(86) PCT No.: PCT/IN2020/050960

§ 371 Date: Mar. 23, 2023

(30) Foreign Application Priority Data
Sep. 23, 2020 (IN) 202041041284

(51) Int. Cl. G06F 16/9536; G06Q 50/00; G06F 16/2457; G06F 16/9535; G06N 5/02

(52) U.S. Cl. CPC G06F 16/9536; G06Q 50/01; G06F 16/24578; G06F 16/9535; G06N 5/02

(57) ABSTRACT

An approach is provided for flock recommendation for people and activities. Flock can themselves either be people or activities. The system takes input from the social accounts associated with the person, and a personality test filled in by the user, activities data from multiple third party sources and recommends them with flocks (either persons for a particular activity or activities for a group of people). It also stores an encrypted combination of user and evidence as transaction in the block chain for every recommendation done for auditing purposes. The ranking module in one embodiment, takes the result set from the recommendation module, ranks them based on the user's preferences. It considers a lot of factors including the weightages of the edges in the knowledge graph and the user info to rank these recommendation result set and finally returns them with rank score.

In recent years, social networking has become a part of the society. Social Networking maintains a digital view of the real world connections, thus connecting users to other users, businesses, entities etc. It also provides a mechanism for the users to be connected to the content that is more relevant to them. For example, users can connect with other users/groups based on their interests, location preference, age and multiple other attributes.

Recommendation Systems are systems which recommend people with these content which can be an entity, an activity or even another person who is more likely to be relevant to him and the context. Also, advertisers use these recommendation systems to show advertisements based on the user preference.

Although these recommendation systems have existed, but they not very relevant when it comes down to real world experiences. Using the data in a social network, they are unable to get the desired results. Moreover, these systems are an internal part of these social networks and don't give the control to the user to find flock recommendations based on his preferences.

### FIELD OF INVENTION

This invention relates to the field of study of patterns of interest and matters of esoteric interests among people with similar nature and grouping them. Still further, this invention relates to the field of recommending groups of people flocked together for any particular area of interest for any activity. Furthermore, this invention relates to a Further, this invention relates to enable a person gain significant control to engage in purposeful interaction in the real world.

### BACKGROUND OF INVENTION

There have been various types of recommendation systems which have been attempted in the past but they do not address or solve the problem of explicit flock recommendations along with evidence of any preferred choice of any given individual. The recommendation systems have been implicit not allowing the user to have control his/her queries. Moreover, the recommendations do not possess the capacity of encouraging transparency in the systems.

Hence there lies a need for a utility which brings a new outlook of recommendation systems. It allows flock recommendation for a particular set of activities and activity recommendations for a flock thus giving more control to the user to use the information. This invention aims to engage more people to socialize in the real world rather than in social media platforms.

### OBJECT OF THE INVENTION

It is a primary object of the present invention to provide a device based upon an application and approach for flock recommendation for people and activities.

In another aspect and object of the present invention to provide a system, which takes inputs from the social accounts associated with the person, and a personality test filled in by the user, activities data from multiple third party sources and recommends them with flocks (either persons for a particular activity or activities for a group of people).

It is yet another aspect of the present invention to provide also stores an encrypted combination of user and evidence as transaction in the block chain for every recommendation done for the purpose of auditing.

It is further object of the present invention to provide, an approach for flock recommendation for people and activities and thus people can flock themselves either as individuals or for group activities

It is still further an aspect of the present invention to provide an encrypted combination of user and evidence as transaction in the block chain for every recommendation done for auditing purposes.

### SUMMARY OF THE INVENTION

A Flock Recommendation Engine which utilizes user's activities and interests based on personality tests and other social networks information to give him a relevant user experience in terms of recommendations, and giving him significant control to engage in purposeful interaction in the real world.

Flock Recommendations in terms of other people as flocks (suggested for activities) or activities as recommendations (suggested for a flock of people). Blockchain Auditing by committing all the recommendations and evidence in an encrypted form into the blockchain. Promotion of meaningful real world interaction by engaging people with activities/people that are more relevant to his/her interests. In one embodiment, these flock recommendations are displayed in the mobile app, or web feed, or text message, email or an application user interface.

### BRIEF DESCRIPTION OF THE DRAWINGS

FIG. 1 illustrates the flock engine environment to recommend relevant flocks or relevant activities for the flocks.

FIG. 2 is a block diagram of the core flock engine.

FIG. 3 is a block diagram of the block chain auditing system.

FIG. 4 is a process diagram describing the flow of hyper personalization of the user by taking the personality tests and connecting with other social networks.

FIG. 5 is a process diagram describing the flow of the system connecting to third party sources for events activities information.

FIG. 6 is a flow diagram of real time flock recommendation based on a user's query.

FIG. 7 illustrates the real world applications/devices that can enable the flock engine for recommendations.

FIG. 8 illustrates the network and hardware support for the flock recommendation engine.

FIG. 9 shows an embodiment of the flock recommendation based on a particular activity.

FIG. 10 shows an embodiment of the activities recommendations based on a flock.

FIG. 11 shows an embodiment of the detailed description of the recommendation.

FIG. 12 shows an embodiment of the flock chat where members of the flock can interact with each other.

FIG. 13 shows an embodiment of the personality test taken by the user.

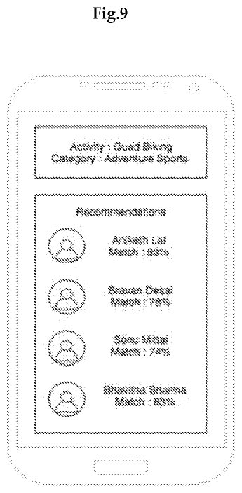

FIG. 9-13 shows different illustrations of the invention in one embodiment. Anyone skilled with user experience could build alternative embodiments for the same without modifying the structure of the core engine framework.

### DETAILED DESCRIPTION OF THE INVENTION

This invention focuses on enhancing the real world experience people witness and help them to get involved in more meaningful interaction and engagement with other people/activities. The flock engine which is the core of this invention recommends flocks of other people for a user for an activity who are most likely to engage in that activity. The flock engine also recommends activities for a flock of users suggesting what activity is most likely to have the maximum engagement with all the users in the flock. The flock recommendations can be displayed in any digital device, either through an app on a mobile device, or a feed in the web, by notifications as email or text message.

To achieve this, a streamlined data and information collection and gathering is performed. User data is collected through various social media sources attached to the user for the user's hyper personalization. Apart from that, data is also collected continuously from various third party sources regarding any activities or events which would be recommended to the user or the flock of user to give him a real time meaningful experience.

The system builds the Persona of each of the users and maintains it in the network and continues to improve and build on it. This persona building can also be referred as hyper personalization. Apart from the data collected from various social media sources for the user, the user in his first time user experience in the app takes a personality test which is an interactive swipe test to answer simple personality based questions. This test helps the system to build an extensive persona of the user considering various factors like values, openness, emotional range, curiosity etc. It helps to build the persona of the user by building an extensive knowledge graph of the user by associating it with all these traits and his likes/dislikes.

The Knowledge Graph is a huge graph containing nodes and edges. Each node refers to any entity, which can either be a user or an entity/activity/event/object/personality trait. The edges connecting the nodes refer to the closeness of the two nodes. The weight of the edge determines the closeness.

The core Flock Engine uses this knowledge graph to make flock recommendations or activity recommendations for the flock. It finds the maximum similarity between two users from the knowledge graph and recommends them flocks of users for an activity. Similarly for a flock of users as a query, it finds the maximum similarity between the activities and recommends them activities form the knowledge graph.

The recommendations made by the flock engine are passed as a transaction to the blockchain along with the evidence. In one embodiment, they are stored in an encrypted form in the blockchain. The evidence includes the traceback or the weightages considered from the knowledge graph to make the flock recommendation. The evidence along with the recommendation is encrypted using an encryption algorithm and added to the blockchain as a transaction. This helps to audit the results and logs for any further use or inspection.

The flock recommendations can be shown in multiple embodiments. They can either be user queries or used by other companies to recommend better products or activities for the user. Advertisers and entities managing campaigns can also use these recommendations to improve their suggestions for the users and come up with better strategies to keep them engaged.

In one embodiment, apart from the initial data collection from social media sources and personality tests for building the persona, the users are asked questions from time to time which help in keeping their persona profile updated in the knowledge graph so to recommend and create a meaningful engagement. Moreover, the activities on the app performed by the user, the time spent on each of these are also passed to the feedback system in the flock engine which generates meaningful insights and updates the system.

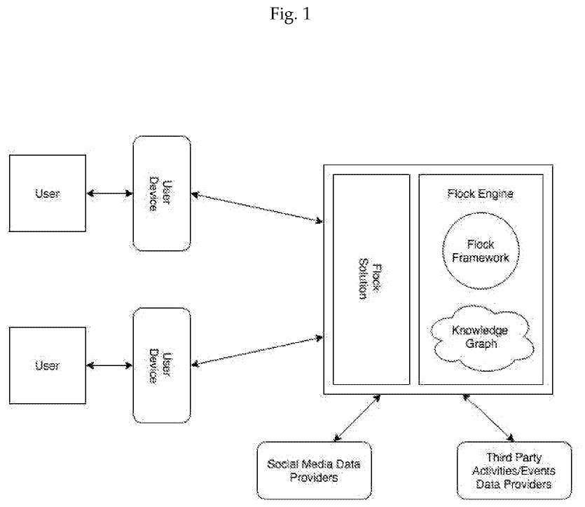

FIG. 1 illustrates an embodiment of the flock system which recommends flocks of people to a user for a particular activity/event and also recommends an activity for a flock of people. The major components in the flock system includes the user who interacts with the system to get recommendations. He engages with the system through a user device which can be a mobile app or web browser or any other device which has a display and has network connectivity. Some of those devices can be an embedded car display device or a smart home display device with network connectivity where user can interact and get the recommendations. These devices can be connected to the Internet either through wifi, or local area network or hotspot or any other similar means.

The social media sources are the next major components in the flock system who play an important role in feeding a lot of already available user info and content into the system. The flock system connects to these social media sources with user's permissions through Application User Interfaces (APIs) and collects data from these sources which provide a lot of insight into user's activities.

The next component in the flock system environment includes the third party data providers who consolidates activities/events in various places related to food, music, concerts, workshops, meetups, tourist activities etc. The flock system also connects to these data providers through Application User Interfaces (APIs) and gathers data from time to time using polling mechanism so that it keeps itself updated with the activities live in the region. The flock system also exposes a push mechanism where the third party data sources can push any event based on any activity update or new activity change into the system.

The major component in the flock system environment is the flock engine. This the core component in the environment which is responsible for flock recommendations for the users. The flock engine contains 3 major sub components. First, being the flock solution which is responsible for engagement with the users by exposing Application User Interfaces (APIs). It also exposes these APIs for any other third party entities/advertisers to consume so as to use this for better recommendations. The flock solution also consolidates all user metadata and acts as a support layer for the flock framework. The flock framework, the second component of the flock engine is the intelligent module in the flock engine which is responsible for making these recommendations. The flock framework queries the knowledge graph based on the requirements and consolidates the information and suggestions for the user. It then ranks the recommendations and finally returns them. The knowledge graph, the third subcomponent of the flock engine, is an ontology graph based network, where each of the nodes is an entity, be it a user or an event/activity or entity. In one embodiment, the nodes are connected to each other by an edge which stores the weight of closeness amongst the two nodes. For example, a user A can be a node in the knowledge graph and he might have a strong connection with Adventure node which is an entity. This ideally means the user A is strongly interested in Adventure sports and so the system might suggest recommendations based on this information.

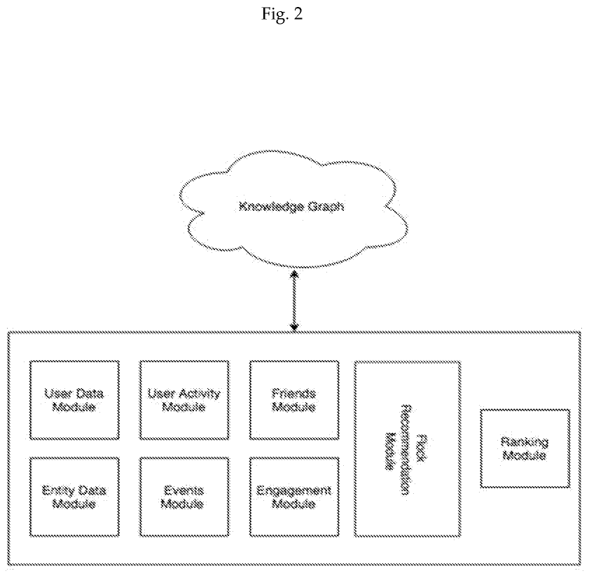

FIG. 2 illustrates a detailed block diagram of the core flock engine. The flock engine contains multiple modules. These modules interact with the knowledge graph and continue to modify the knowledge graph to keep the system updated based on the users info. The User Data Module exposes all the means of interacting, querying and updating any info related to the user. This module consolidates the information it extracts from the social media profiles of the user and feeds it to the knowledge graph in one embodiment. The User Activity Module exposes all means of interacting, querying and updating any user activity performed by the user. These activities are not the activities recommended by the system but device based activities or query based activities performed by the user. For example, the user browsing through and querying for “Adventure” tag can be considered as an activity which can be used to gain insights about a user's preferences. The friends module stores all the friends of the user available in the network and exposes all means of interacting, querying and updating any info related to his/her friends.

The Events Data Module contains all information related to any events or activities in a particular region. In one embodiment, it exposes all means of interacting, querying and updating any events/activities related data in the system. This module takes care of continuously polling the third party sources to keep the events data updated and also exposes a push mechanism for this sources to push any event change into the system. The Entities Data Module in one embodiment, contains all relational mappings between the activities on a broad level. It stores the metadata for these events/activities and classifies/clusters them into categories. The engagement module in one embodiment, exposes all means of interacting, querying and updating any engagement between users/friends or users with activities.

The flock recommendation module in one embodiment, consolidates the information from all these modules to build the result set for the recommendations based on the query. It also connects to the knowledge graph to improve the recommendations.

The ranking module in one embodiment, takes the result set from the recommendation module, ranks them based on the user's preferences. It considers a lot of factors including the weightages of the edges in the knowledge graph and the user info to rank these recommendation result set and finally returns them with rank score.

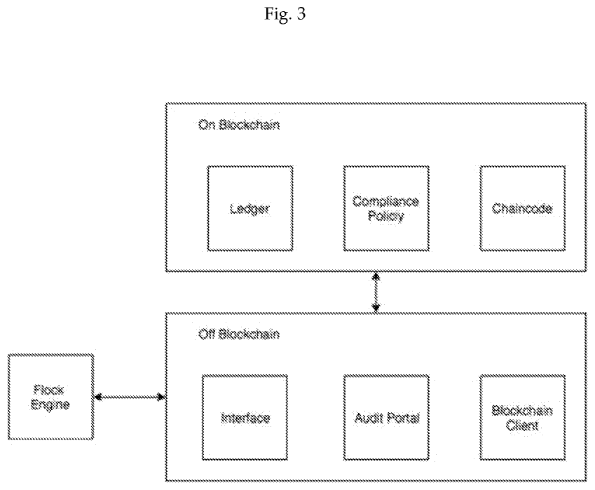

FIG. 3 illustrates the block diagram of the blockchain auditing system. The blockchain auditing system is responsible for transacting all the recommendations done by the flock system for the users. These transactions can further be used for auditing purposes. This blockchain in one embodiment is not a public blockchain and the entity managing the flock framework controls the rights to the blockchain. The auditing system has two major components, the off chain and the on chain.

The on chain blockchain holds the actual blockchain or the ledger, the compliance policy, configurations, and the chaincode. In one embodiment, the recommendation done by the flock engine is encrypted with an encryption algorithm along with the evidence used for the recommendation and then transacted into the ledger. The evidence contains the snapshot of the network, the connections in the knowledge graph between the users and entities used for this piece of recommendation. Along with the evidence, some metadata like timestamp and user info is also a part of the transaction which is feed into the blockchain.

The offchain is outside of the actual ledger or blockchain network but exposes means of connecting and querying the blockchain network. One of the major components is the blockchain client which can connect to the ledger, query, update and add transactions into the network. The other components include the interface and the audit portal which provides a way for a general user to connect, audit, and view the transactions done in the blockchain network.

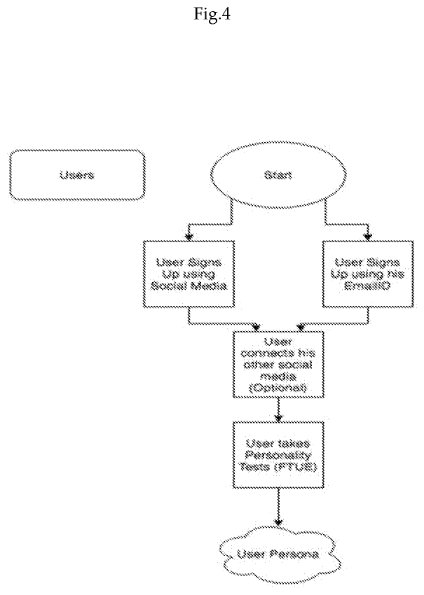

FIG. 4 is a process diagram describing the flow of hyper personalization of the user by taking the personality tests and connecting with other social networks. In one embodiment, the user in his first time user experience while accessing the device for the flock system first has to sign up or login. He has two flows of doing that, either signing up in the system through some social media source he is already connected to. Or he could just register through his email ID. He then has the option to attach his other social media accounts to this profile. This is an optional step and depends on the willingness of the user to share the information in his other social media accounts in this profile of the flock system.

After he has registered into the flock system and attached his accounts, in one embodiment, he has to go through a first time user experience which is a personality test. In one embodiment, the personality test is a simple swipe based question system where the system asks various questions related to various categories based on some famous personality tests. This helps the system to collect and gain a lot of insights about the user building the user persona and feeding it to the knowledge graph. In one embodiment, the personality tests take personality based questions and also likes/dislikes or preference based questions. An example of a personality based question could be, “Are you social?”, while a preference based question could be “Are you interested in Adventure?” In one embodiment, these questions come from time to time on the user's device to improve the user's knowledge graph and keep it updated.

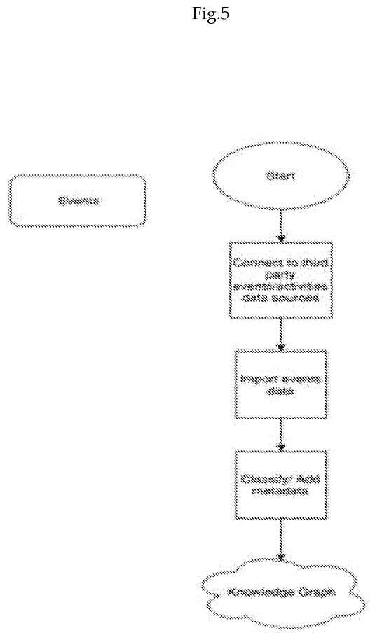

FIG. 5 is a process diagram describing the flow of the system connecting to third party sources for events activities information. In one embodiment, the flock system first connects to multiple third party data sources across various categories. They are spread across events/food/tourism activities, meetups, workshops etc. The Events/Activities module inside the flock system uses a polling mechanism to continuously get new data and keep updated information about these activities/events. It also exposes a push mechanism through which these third party data providers can push any event change into the system.

The flock system then uses Entities Data Module to categorise these events into multiple classes and subclasses to keep ontology based metadata information. This information is then fed onto the knowledge graph. Similar events are strongly connected with each other with a larger weight while events with no similarity are connected by a very small weight between them.

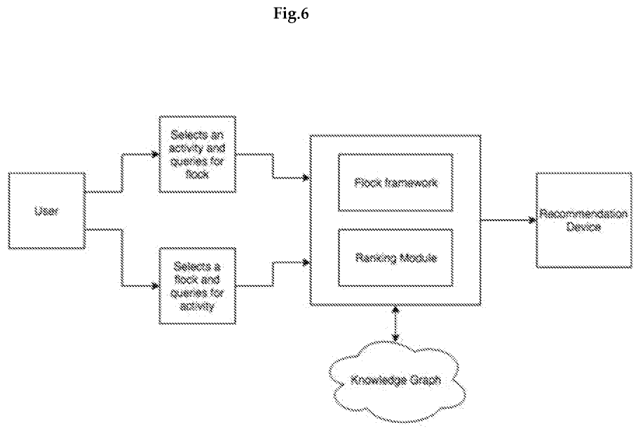

FIG. 6 is a flow diagram of real time flock recommendation based on a user's query. In one embodiment, the user has two flows, either to query for a flock recommendation based on an event or activity, or to query for an activity recommendation based on the flock.

In one embodiment, the user selects the activity/event he/she is interested to do. The flock engine after finding similarities in the user's friends profiles through their knowledge graphs and their likes/dislikes preferences is able to find out the friends who would be most interested in performing this particular activity. It then ranks them and recommends the flocks of his/her friends who are most likely to be interested in such kind of activity.

In another embodiment, the user selects the flock of his/her friends and queries for an activity that is most likely to be engaging for each flock member. The flock engine again finds similarities between the users involved in the flock and finds out the activity similarity amongst all users in the flocks. It then uses ranking module to rank them and then recommends it to the users through the device.

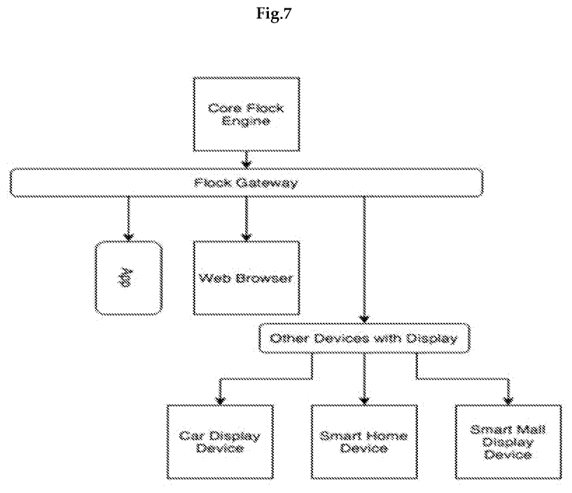

FIG. 7 illustrates the real world applications/devices that can enable the flock engine for recommendations. The recommendations can be displayed in any device which ensures a display and network connectivity.

In one embodiment, the recommendations are displayed in the mobile device application. In another embodiment the recommendations are displayed in the feed of the web browser. In another embodiment, the recommendations are displayed in smart devices like smart car display device, smart home device, or smart mall device.

In another embodiment, the recommendations can also be consumed by other advertisers or third party applications through an Application User Interfaces (APIs).

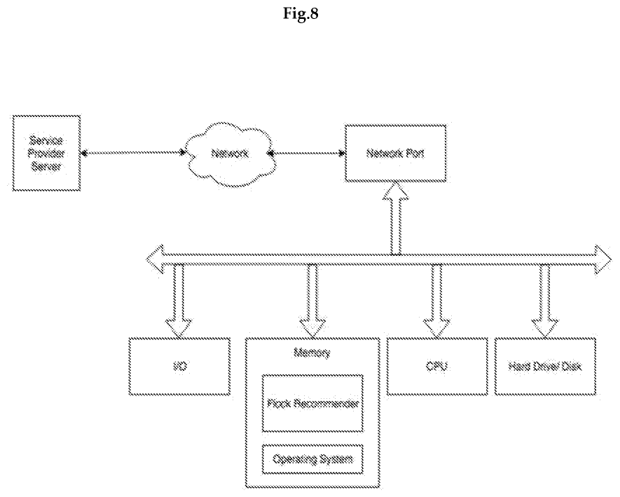

FIG. 8 illustrates the network support for the flock recommendation engine. The recommendation engine is implemented on top of an Operating System along with memory. The engine talks to other components like I/O devices for interaction with the engine, Hard Disk/drive for persistence and storing data and CPU or any such computer processors to execute the instructions. Any similar embodiment comprising of such components could implement the flock engine setup.

FIG. 9 shows an embodiment of the flock recommendation based on a particular activity. In one embodiment, the user selects the activity or group of activities. In another embodiment, he can also select a category of activities from an already available activity list. Once he selects an activity, the system recommends him a flock of users amongst his friends connected to his network. It recommends the most relevant flock of users who are most likely to engage in that particular activity. In one embodiment, the flock engine also displays the match percentage, that is how likely the recommended user is to engage in that activity in terms of percentage. In another embodiment, the flock engine also shows the evidence why the flock has been recommended to the user. For example, User A might be interested in Sand Adventure Sports. User B might be interested in Quad Biking which is a sand adventure sport and so has been recommended.

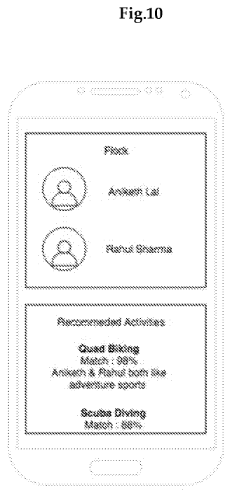

FIG. 10 shows an embodiment of the activities recommendations based on a flock. In one embodiment, the user selects a flock of people amongst his friends. He can select one or more friends for the flock. The flock engine recommends him a group of activities that is most likely to have maximum engagement amongst all users in the flock so as to ensure everyone in the flock is likely to be satisfied in performing the activity. In one embodiment, the user along with the flock of users also selects the category of event, which would recommend all similar activities lying under that particular category. For example, the user selects A & B who are amongst his friends connected to his network, all three of them interested in adventure sports. The flock engine is likely to recommend Quad Biking as a recommendation to the flock.

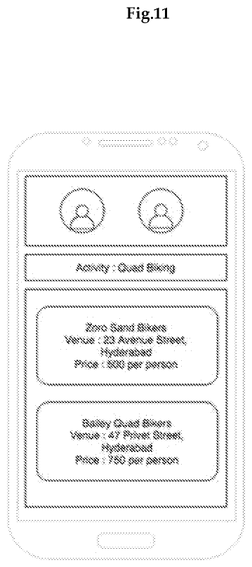

FIG. 11 shows an embodiment of the detailed description of the recommendation. In one embodiment, the recommended activity for the flock has a detailed description page which holds information about the activity. In one embodiment, it holds information about the organisers or entities holding the event/activity, the venue or the location of the event in case it's a physical event, the price or the fees involved in the event and so on.

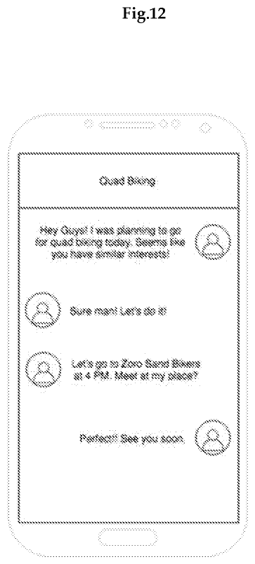

FIG. 12 shows an embodiment of the flock chat where members of the flock can interact with each other. In one embodiment as illustrated in the figure, the flock recommended for a particular activity for a user are automatically added to a temporary flock group. The temporary flock group is not a permanent group and deleted/archives automatically after an estimated time interval depending on the activity the flock intends to perform. In one embodiment, the chat window allows the users in the flock to interact with each other using text and media messages. The flock engine also makes suggestions in the chat window recommending places for the activity and a detailed description page of the activity/event.

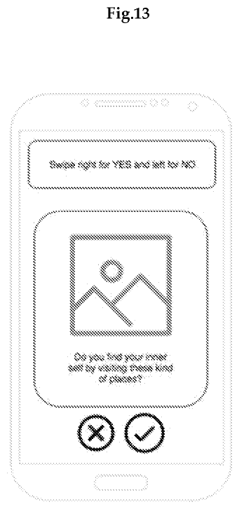

FIG. 13 shows an embodiment of the personality test taken by the user. In one embodiment, the user is asked swipe based personality questions. For example, in the embodiment illustrated in the figure, it asks if the user is likely to find his inner self visiting such places. This illustrates the personality type of the user if he is interested in a calm peaceful place or he is more interested in adventure. In one embodiment, the personality tests comprise of multiple category of questions which can vary across personality type, intelligence level, emotional quotient, likes/dislikes and preferences. The personality tests analyse the results and build the knowledge graph by adding user information.

This invention describes an embodiment of the invention but the scope of the invention is not limited to the description of this invention. The embodiments of this invention are exhaustive and anyone skilled in user experience or in this art can bring out more innovative embodiments of this invention.

The embodiments of the invention describe at some portions algorithms or logic for the invention, while some other portions describe information and some other portions describe the user experience for this invention. The algorithms and logic can be implemented by people skilled in computer science or programmers or architects skilled in this field who understand the terms related to computer science. The network support operations can be taken up by the people who are skilled in computer networks. The devices are the hardware operations can be understood by the people who have relevant experience in hardware, firmware and similar systems. The different embodiments of the screens described in the devices can be implemented by the people who have relevant skills in user experience.

Embodiments of the invention can be implemented with any device, be it a mobile app or a web browser or a smart home/car device with network connectivity. In another embodiment, they can be exposed via application user interfaces. Another embodiment can also be computer software which could be executed by the computer processor for all of its operations.

The language used in the description is used for instructional and descriptive purposes. It is not intended to limit the scope of this invention. The embodiments are just meant for illustration purposes of the scope of the invention which is set forth in the following claims.

What is claimed is:

1. A method to match recommendations for an activity for a flock of users or flock of users for an activity, the said method comprising of steps including Provision of connection to the network to get an access to these party sources and collect relevant data,
Gathering of information and data related to the user and the events/activities from third party sources through the network,
Extracting of user information through multiple personality tests,
Consolidation of user information from social media sources and personality tests,
Hyper personalization by building user's knowledge graph attaching user's likes and dislikes to the knowledge graph,
Categorization of the events/activities data by maintaining a concept graph for the entities,
Recommendation of flocks of users for an activity and recommending an activity for a flock of users,
Ranking of the recommendations based on user's likes/dislikes and user activity,
Transmittal of the recommendations to the user via a user device.

2. The method as claimed in claim 1, wherein said network includes one or more servers connected to one or more user devices via the network.

3. The method as claimed in claim 1, wherein said data related to the user includes data from social media sources about his/her likes/dislikes and other preferences.

4. The method as claimed in claim 1, wherein said personality tests include questions based on personality type, intelligence, interpersonal skills etc.

5. The method as claimed in claim 1, wherein said knowledge graph includes the network between users and events, entities.

6. The method as claimed in claim 1, wherein said data related to events includes events or activities related to food, tourism, adventure and meetups, workshops etc.

7. The method as claimed in claim 1, wherein said flock recommendations includes analysis based on preference, relevance and engagement.

8. The method as claimed in claim 1, wherein said user device includes a mobile app, web browser, smart display systems like smart home, smart cars, smart mall display systems.

9. The method as claimed in claim 3, wherein said user data includes current, recent, last known and estimated location of the user.

10. The system, substantially described as above required for flock recommendations includes,
Plurality of processors, memory devices coupled to the processor to execute the instructions, and module for network connectivity to transmit and consume data across the network.
